(19) United States
(12) Patent Application Publication
(10) Pub. No.: US 2011/0043881 A1
(43) Pub. Date: Feb. 24, 2011

(54) DEVICE AND PROCESS FOR CONTROLLED CONVEYING OF DIFFERENT VISUAL IMPRESSIONS OF A ROOM WHILE RETAINING IDENTICAL ROOM ILLUMINATION

(75) Inventor: Reinhold Elferich, Aachen (DE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/990,653

(22) PCT Filed: Apr. 30, 2009
(86) PCT No.: PCT/IB09/51766

§ 371 Date: Nov. 2, 2010

(30) Foreign Application Priority Data
May 7, 2008 (EP) 08103843.2

(51) Int. Cl. G02B 26/02

(52) U.S. Cl. 359/227

(57) ABSTRACT

The invention concerns a device for the controlled conveying of different visual impressions of a room while retaining identical room illumination, consisting of at least two sources of light and at least one set of shutter glasses, where at least one of the light sources (La, Lb, Lc) is chronologically pulse controlled and the shutter glasses (S1, S2) are synchronised with a least one of the pulsed sources of light (La, Lb, Lc). The invention also concerns a process for conveying individual impressions of a room while retaining identical room illumination

### FIELD OF THE INVENTION

The invention concerns a device for controlled conveying of different visual impressions of a room while retaining identical illumination comprising at least two sources of light and at least one set of shutter glasses. The invention also concerns a process for conveying individual impressions of a room while retaining identical room illumination.

### BACKGROUND OF THE INVENTION

In the designing of public rooms such as sales premises, museums and hotels, the planning of illumination has high priority. By using different types of lighting such as wall lighting, accentuated lighting, decorative lighting as well as general lighting, the aim is to give a room spatial identity while emphasising certain areas and objects. The interplay of different types of lighting creates what is known in the field of architecture as a “visual environment” which accentuates important areas while diverting attention from those which are less important.

One problem in the planning of interior illumination is the fact that the assessment of areas or objects with regard to importance is subjective, i.e. different observers may have different criteria for the selection and arrangement of lighting. For example, different combinations of colour may be more attractive to different age groups, or, in a museum, different epochs may receive more attention. In sales rooms on the other hand, different groups of products or offers may be of interest to different income groups. However, current illumination techniques are only capable of achieving a compromise which fulfils the requirements of different target groups to the greatest extent possible.

### SUMMARY OF THE INVENTION

A purpose of the invention is to remedy this situation by providing a device which, with identical illumination, conveys different visual impressions of a room in a defined way. According to the invention, this purpose is fulfilled by the features described in the characterising section of patent claim no. 1.

With the invention, a device is provided which, while retaining identical illumination, allows different visual impressions of a room to be conveyed in a defined way. By synchronising the shutter glasses with at least one of the pulsed sources of light, certain light signals are suppressed by means of which the visual impression obtained by the observer is modified.

Shutter glasses are familiar in the field of three-dimensional perception of images. These are special glasses whose lenses consist of two liquid crystal displays (one for the left and one for the right eye) which can be controlled electronically to make them translucent or opaque. In this way, either the left or the right eye can be “blacked out”. With shutter glasses of this kind it is possible to view stereo images on a monitor. The images transmitted to the monitor are photographed by two different cameras. By means of an image mixer, one field is used for the left and one for the right eye. The shutter glasses used in the present invention make use of only one shutter surface which can be switched from the transparent to the non-transparent state or between clear and dim.

In a further variation of the invention, the shutter glasses are fitted with a module for controlling the shutter sequence. This makes it possible to control the shutter sequence individually. The shutter glasses may therefore have a pre-set shutter pattern or a receiver unit by means of which the shutter sequence is controlled without contact from outside.

A further development of the invention has a control unit for the precise control of at least one tested light source which is connected to a unit for storing different pulse sequences. This makes it possible to control the pulse frequency of the light source according to a previously defined pattern.

Preferably, a synchronisation module for the contact-free synchronisation of at least one tested light source and at least one set of shutter glasses are provided, thereby ensuring the required synchronisation between the shutter glasses and the source of light.

In a further development of the invention, the shutter glasses comprise lenses of electro-optically active material which can be switched between the transparent and the non-transparent state.

In an alternative development of the invention, the shutter glasses can be switched between the states of clear and dim. The shutter glasses preferably have shutter speeds of less than 10 ms.

In an advantageous development of the invention, the shutter glasses have a transmission of less than 10% in the closed state. Preferably, the shutter glasses have a transmission of over 50% in the open state. In this way, sufficient brightness of the visual impressions perceived through the shutter glasses is achieved. In all cases, the transmission should be more than 30% in the open state. In the closed state it should be at least five times and preferably ten times less. The relation of the transmission achieved in the open state to that achieved in the closed state is decisive for the brightness of the visual impressions perceived through the shutter glasses.

Furthermore, the purpose of the invention is to provide a process which makes it possible to convey individual impressions of a room while retaining identical lighting. According to the invention, this purpose is fulfilled by the features described in the characterising section of claim no. 10.

In a development of the invention, at least one source of light is provided for accentuation of an object within the room. In this way, individual objects can be accentuated for certain defined observers.

In a further development of the invention, at least one source of light is provided as decorative illumination. In contrast to accent illumination, decorative illumination does not contribute significantly to the lighting of the room in the sense of making it brighter. Decorative illumination plays an important part in creating an atmosphere. It may consist for example of backlit display cases containing a certain advertising message.

In a further variation of the invention, at least one pulsed source of light is provided as a “signpost”. This permits implementation of an individual guidance system for visitors or customers, where in shutter sequences certain signposts are emphasised for certain groups of persons.

In a further development of the invention, the shutter sequence of at least one set of shutter glasses is controlled externally without contact in order to create certain visual impressions. In this way, information can be transmitted individually to the user of the shutter glasses. For example, certain aspects of a possible offence may be illuminated in a certain way for transmission to a store detective.

The invention also concerns the use of shutter glasses for conveying different visual impressions of a room in a specific way while retaining identical illumination.

Further developments and variations of the invention are described in the sub-claims. An example of the invention is shown in the drawings and is described in detail below.

### BRIEF DESCRIPTION OF THE DRAWINGS

The figures are as follows:

FIG. 1 Schematic diagram of an example of the synchronisation of two (sets of) shutter glasses with two opposing pulsed sources of light.

FIG. 2 Schematic diagram of two (sets of) shutter glasses with three different pulsed sources of light combining the light from the different sources.

FIG. 3 Schematic diagram of the synchronisation of two (sets of) shutter glasses with one pulsed source of light (light source controlled).

FIG. 4 Schematic diagram of the synchronisation of two (sets of) shutter glasses with one pulsed source of light (shutter glasses controlled).

FIG. 5 Schematic diagram of a pulse signal from one light source with superimposed synchronisation signals.

FIG. 6 Schematic diagram of a pulse signal from one light source with superimposed light modulation for identification of the light source.

FIG. 7 Schematic diagram of the synchronisation of two (sets of) shutter glasses with three light sources with short switch-on time.

FIG. 8 Schematic diagram of the conveying of visual impressions of a room illuminated by three sources of light,
a) for an observer with a first set of shutter glasses and
b) for an observer with a second set of shutter glasses whose shutter sequence differs from that of the first set of shutter glasses.

### DETAILED DESCRIPTION OF EMBODIMENTS

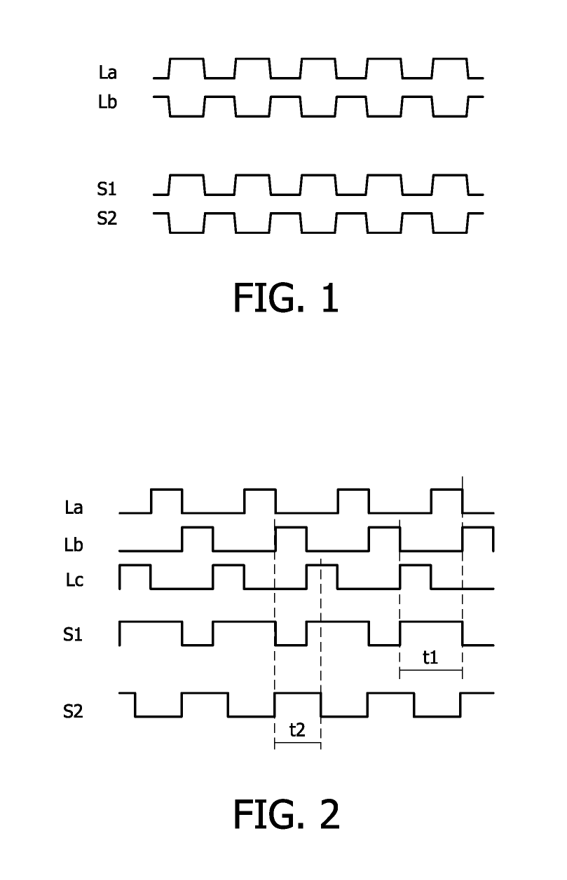

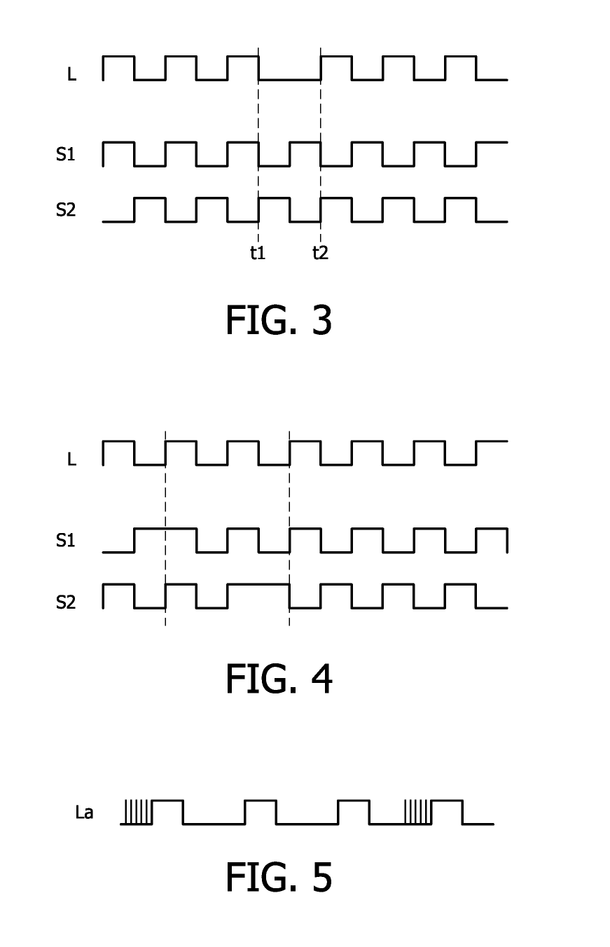

The example selected of a device for the controlled conveying of different visual impressions of a room while retaining identical illumination consists of two pulsed sources of light La and Lb which are differently pulsed over time, i.e. the sources La and Lb light at different times. In the example shown in FIG. 1, the shutter glasses S1 and S2 are synchronised and work on a set pattern. FIG. 1 shows the simple case where one light source (or a group of light sources) is assigned to one set of shutter glasses (or a group of shutter glasses) in the sense that the shutter of the shutter glasses is only open when the lamp assigned to it is switched on. Shutter sequences may also be used which combine the light from different light sources (or groups of light sources) according to a fixed pattern as shown, for example in FIG. 2. In this way it is possible to show dynamic illumination scenes. FIG. 3 shows an example of a lighting pattern which is perceived by the observer behind the shutter glasses S1 as light L being switched off at moment t1, whereas to the observer behind shutter glasses S2 it appears to be switched on at moment t2.

In contrast to the above examples in which a set of shutter glasses is controlled according to a set pattern, a set of shutter glasses can also be controlled, for example, according to location, by actions of the user or in similar ways. In this case, an illumination pattern is provided as a basis on which a set of shutter glasses, whose shutter sequence is controlled individually by a shutter-control system, composes the illumination scene. In this way a set of shutter glasses can be controlled in such a way that certain illuminated or luminous signs, or lights at entries, exits, access routes etc. appear to the observer to flash or light up particularly brightly, whereas to other observers without glasses or with a different set of glasses, they have no particular significance even though they may be illuminated. A similar effect may also be achieved for sales rooms and displayed objects or for general exhibitions such as museums.

FIG. 8 shows the different visual impressions obtained by two users with two different (sets of) shutter glasses S1 and S2. The light sources La and Lb are synchronised with the shutter glasses S1 and S2 in the same way as shown in FIG. 1. In addition to the first variant, where the pulsed light source is controlled and the shutter glasses have a constant pre-set shutter pattern, and the second variant, where the light sources have a (constant) pulse pattern and the shutter sequences are controlled externally, thereby achieving the desired visual impression, a third variant is also possible, where the light sources are controlled and shutters with (constant) pre-set shutter patterns as well as externally controlled shutters are used, for example by making dynamic lighting systems visible individually.

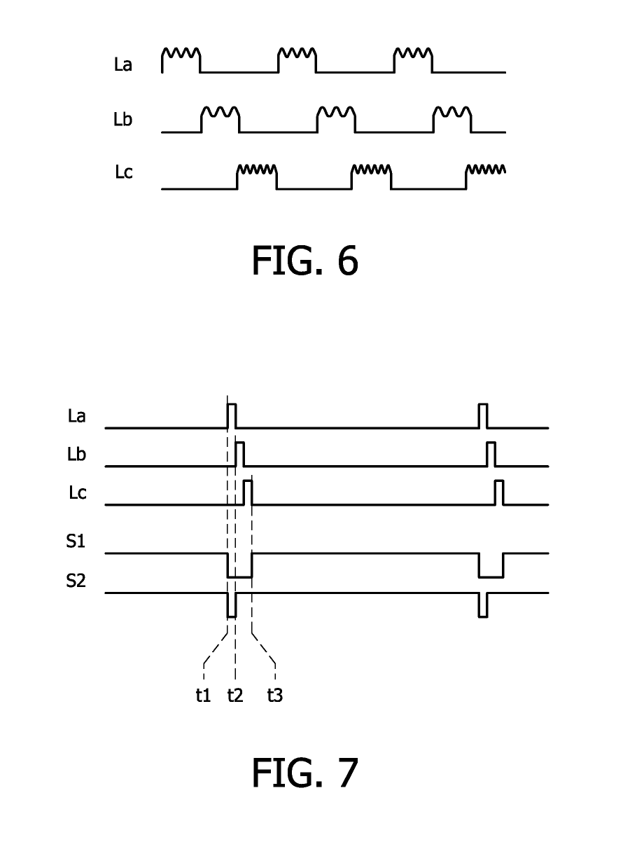

In all the cases described above, the shutter of the shutter glasses has to be synchronised with the corresponding sources of light. This may take place by means of an RF signal which determines the timing of light source and shutter which are fitted with an RF antenna. Alternatively the sources of light may also emit a visual synchronisation signal, e.g. by means of an additional light source with a high-frequency modulation capability or a synchronisation signal as shown in FIG. 5. For this purpose the shutter is fitted with an optical sensor. The signal from the light source La has a synchronisation identification in form of a pulse pattern which precedes the actual switching on at certain intervals, thereby making synchronisation possible. This identification can also be used for distinguishing between different sources of light for controlling the shutter. This is particularly necessary when the chronological coordination (or even the existence) of all the light sources in a room is not known. FIG. 6 shows a further possibility for identification of light sources for the shutter glasses by means of a superimposed light modulation.

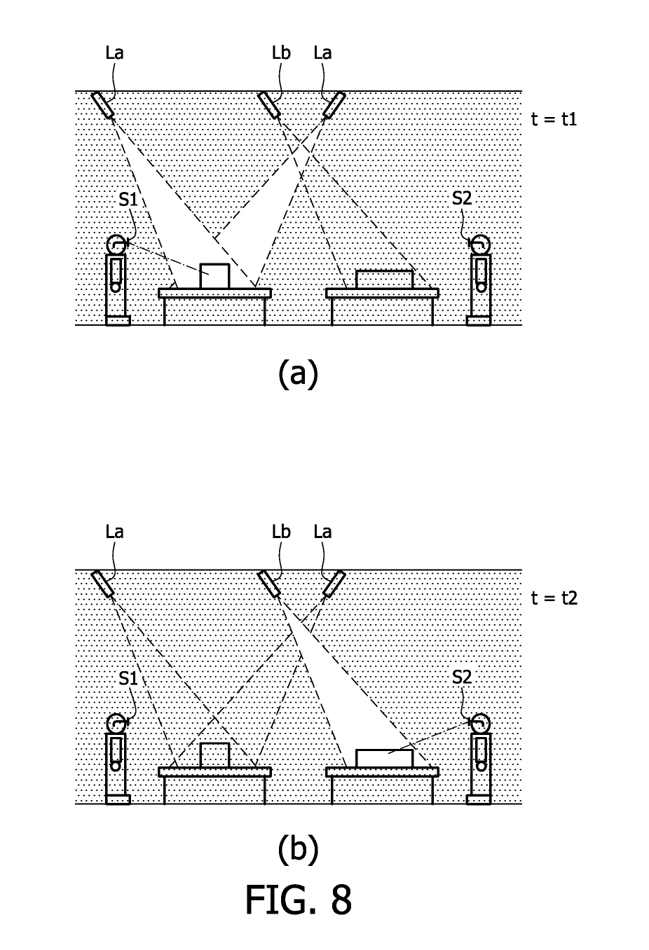

In cases where general lighting is kept at a very low overall level, for example with regard to observers who are not equipped with a set of shutter glasses, but whose function is intended to be used (e.g. for guidance in large buildings or plants), the sources of light can be operated with a very low duty cycle. FIG. 7 shows the chronological light sequence of three sources with short switch-on times (but in which the light sources can light up correspondingly brightly). This allows long switch-on times for the shutter with the result that the average transmission factor is close to the maximum transmission factor of the shutter glasses, even if, for example, shutter glasses S1 are closed during the switch-on times (t1 to t3) of all three light sources La, Lb and Lc, so that these light sources appear darkened to the observer behind shutter glasses S1. Through shutter glasses S2 on the other hand, the observer sees both light sources Lb and Lc since only La is “darkened”.

Shutters allowing closing and opening times of less than 10 ms (preferably less than 1 ms) have proved to be particularly suitable. At the same time it is important that the wearer of the shutter glasses experiences as little discomfort as possible with regard to its weight and power consumption. The transmission of the shutter glasses in their open state should be as high as possible, (over 30%) to ensure that an average transmission factor of approx. 15% is achieved for an average duty cycle of around 50%. This is approximately equivalent to sunglasses of category 3. Preferably the transmission should be over 50%. In the closed state, the transmission should be at least five and preferably ten times less, i.e. less than 10% but preferably less than 2%. The relation of the transmission in the open state to that in the closed state is decisive for the brightness of the visual impressions perceived through the shutter glasses.

Standard shutter glasses make use of LC technologies whose transmission is well below 50% (due to the principle on which they function) and whose shutter speeds are between 0.1 and 20 ms. Shutters can also be used which are based on the control of the reflection characteristics of an element in the beam path. Besides shutters whose transmission is controlled, types of shutter can also be used whose state can be switched between bright and dim. In the bright state, shutters of this type have transmission factors of between 80% and 90%.

1-15. (canceled)

16. A set of shutter glasses for giving a first visual impression to an observer who is wearing the set of shutter glasses while another observer who is not wearing the set of shutter glasses or who is wearing a different set of shutter glasses is getting a second visual impression different from the first visual impression, the set of shutter glasses comprising a module for controlling a shutter sequence for synchronizing the shutter glasses with a light source for producing pulsed light, the module comprising a receiving unit for receiving a control signal for controlling the shutter sequence externally without contact.

17. The set of shutter glasses according to claim 16, wherein the control signal comprises a radio frequency signal.

18. The set of shutter glasses according to claim 16, wherein the control signal comprises a visual synchronization signal.

19. The set of shutter glasses according to claim 18, wherein the visual synchronization signal being synchronization information in the pulsed light.

20. The set of shutter glasses according to claim 19, wherein the synchronization information in the pulsed light being in the form of a pulse pattern preceding an actual switching.

21. The set of shutter glasses according to claim 19, wherein the synchronization information in the pulsed light being a superimposed light modulation.

22. The set of shutter glasses according to claim 16, wherein the set of shutter glasses has a shutter speed of less than 10 ms.

23. The set of shutter glasses according to claim 16, wherein the set of shutter glasses in a closed state has a transmission of less than 10%.

24. The set of shutter glasses according to claim 16, wherein the set of shutter glasses in an open state has a transmission of over 30%.
